(19) United States
(12) Patent Application Publication
(10) Pub. No.: US 2026/0069979 A1
(43) Pub. Date: Mar. 12, 2026

(54) INTERACTIVE PROCESSING METHOD, ELECTRONIC DEVICE, AND STORAGE MEDIUM

(71) Applicant: Lenovo (Beijing) Limited, Beijing (CN)

(72) Inventors: Jing LIU, Beijing (CN); Anna TANG, Beijing (CN)

(21) Appl. No.: 19/310,196

(22) Filed: Aug. 26, 2025

(30) Foreign Application Priority Data
Sep. 6, 2024 (CN) 202411252471.1

(51) Int. Cl. A63F 13/56

(52) U.S. Cl. CPC A63F 13/56

(57) ABSTRACT

An interactive processing method, an interactive processing apparatus, and an electronic device are provided. The interactive processing method includes: obtaining operating information of an electronic device; and configuring a target intelligent agent of the electronic device to have a target virtual image based on the operating information. The target intelligent agent is able to update constituent elements of a virtual image of the target intelligent agent in response to a change in the operating information.

### CROSS-REFERENCE TO RELATED APPLICATION

This application claims priority to Chinese Patent Application No. 202411252471.1, filed on Sep. 6, 2024, the entire content of which is incorporated herein by reference.

### TECHNICAL FIELD

The present disclosure generally relates to the field of artificial intelligence technologies and, more particularly, to an interactive processing method and apparatus.

### BACKGROUND

Currently, costumes of virtual assistants in games are usually obtained by players manually purchasing and unlocking specific suits, or completing specific tasks. However, such method of obtaining costumes lacks flexibility and real-time performance.

### SUMMARY

In accordance with various embodiments of the present disclosure, there is provided an interactive processing method. The method includes: obtaining operating information of an electronic device; and configuring a target intelligent agent of the electronic device to have a target virtual image based on the operating information. The target intelligent agent is able to update constituent elements of a virtual image of the target intelligent agent in response to a change in the operating information.

In accordance with various embodiments of the present disclosure, there is also provided an interactive processing apparatus. The apparatus includes: an acquisition unit, configured to obtain operating information of the electronic device; and a processing unit, configured to configure a target intelligent agent of the electronic device to have a target virtual image based on the operating information. The target intelligent agent is able to update constituent elements of a virtual image of the target intelligent agent in response to a change in the operating information.

In accordance with various embodiments of the present disclosure, there is also provided an electronic device. The electronic device includes one or more processors and a memory containing a computer program that, when being executed, causes the one or more processors to perform: obtaining operating information of the electronic device; and configuring a target intelligent agent of the electronic device to have a target virtual image based on the operating information. The target intelligent agent is able to update constituent elements of a virtual image of the target intelligent agent in response to a change in the operating information.

In accordance with various embodiments of the present disclosure, there is also provided a non-transitory computer readable storage medium containing a computer program that, when being executed, causes at least one processor to perform: obtaining operating information of the electronic device; and configuring a target intelligent agent of the electronic device to have a target virtual image based on the operating information. The target intelligent agent is able to update constituent elements of a virtual image of the target intelligent agent in response to a change in the operating information.

### BRIEF DESCRIPTION OF THE DRAWINGS

FIG. 1 is a flow chart of an exemplary interactive processing method consistent with various embodiments of the present disclosure.

FIG. 2 is a flow chart of another exemplary interactive processing method consistent with various embodiments of the present disclosure.

FIG. 3 is a flow chart of another exemplary interactive processing method consistent with various embodiments of the present disclosure.

FIG. 4 is a flow chart of another exemplary interactive processing method consistent with various embodiments of the present disclosure.

FIG. 5 is a flow chart of another exemplary interactive processing method consistent with various embodiments of the present disclosure.

FIG. 6 is a schematic structural diagram of an exemplary interactive processing apparatus consistent with various embodiments of the present disclosure.

FIG. 7 is a schematic structural diagram of an electronic device consistent with various embodiments of the present disclosure.

### DETAILED DESCRIPTION OF THE EMBODIMENTS

Specific embodiments of the present disclosure are hereinafter described with reference to the accompanying drawings. The described embodiments are merely examples of the present disclosure and should not be regarded as limitations of this application. All other embodiments obtained by those of ordinary skill in the art without creative efforts fall within the scope of protection of the present disclosure.

Unless otherwise defined, all technical and scientific terms used in the present disclosure have the same meaning as those generally understood by those skilled in the art to which the present disclosure belongs. The terms used herein are only for the purpose of describing the present disclosure and are not intended to limit the scope of the present disclosure.

In the following description, “some embodiments”, “this embodiment”, one embodiment”, and “examples”, etc., describe subsets of all possible embodiments. But it is understood that “some embodiments” can be the same subset or different subsets of all possible embodiments, and can be combined with each other without conflict.

In the following description, the terms “first/second/third” or similar terms involved are only used to distinguish similar objects, and do not represent a specific order for the objects. It is understandable that items described by “first/second/third” may be interchanged with a specific order or sequence where permitted, such that the present disclosure described here can be implemented in an order other than that illustrated or described here.

In the present disclosure, the term “and/or” is only a kind of association relationship describing associated objects, indicating that there can be three types of relationships. For example, “object A and/or object B” may represent: object A exists alone, object A and object B exist at the same time, or object B exists alone.

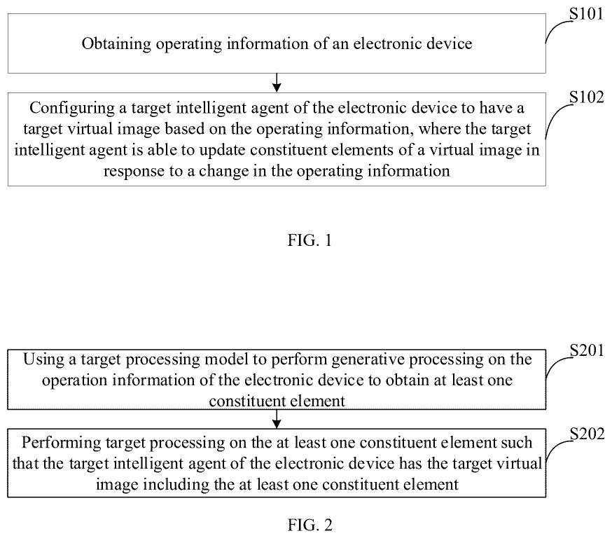

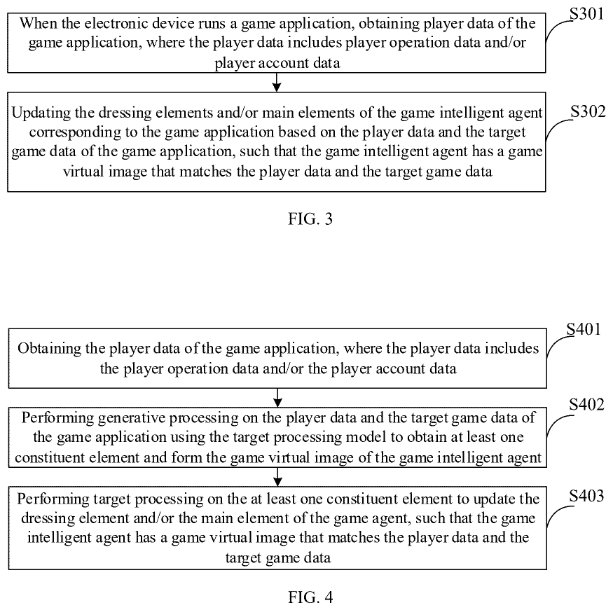

The present disclosure provides an interactive processing method. FIG. 1 is a flow chart of an interactive processing method provided by an embodiment of the present disclosure, which may be applied to an electronic device. The electronic device may be a smart phone, a tablet, a desktop computer, or another device. As shown in FIG. 1, in one embodiment, the interactive processing method may include:

S101: obtaining operating information of the electronic device; and

S102: configuring a target intelligent agent of the electronic device to have a target virtual image based on the operating information, where the target intelligent agent may update constituent elements of a virtual image of the target intelligent agent in response to a change in the operating information.

In one embodiment, the operating information may include information generated during the operation of the electronic device or the information representing the operation state or operation process of the electronic device. The operating information may include at least one of operating application information, operating mode information, operating configuration information, operating duration information, operating environment information, or historical operation data.

The operating application information may be data of the application being run. The operating application information may include at least one of the application name, the application type, the application progress, the highlight moment (the specific application display interface), or the application-specific element, of the currently operating application.

The operating mode information may be information about the operating mode of the electronic device. The operating mode information may include at least one of the performance mode, the silent mode, the balance mode, the audio-video mode, the game mode, the conference mode, or the noise reduction mode.

The operating configuration information may be configuration operating information on a target interface of the electronic device by the user, which is used to configure operating modes, hardware parameters, software interface parameters, etc. of the electronic device.

The operating duration information may be duration information of the operating process of the electronic device.

The operating environment information may be information about the surrounding environment of the electronic device. The operating environment information may include at least one of object information in the spatial environment (such as crowded or not crowded, indoors or outdoors), ambient brightness, ambient color temperature, or ambient noise.

The historical operation data may be data generated by the operation of the electronic device at a historical moment.

In one embodiment, the electronic device may include a collection unit (or an acquisition unit) for obtaining the operating information of the electronic device.

In one embodiment, the target intelligent agent may be a virtual assistant of the electronic device. The user may perform operations such as query, control, generation, etc., with the virtual assistant of the electronic device through voice or text instructions. The virtual assistant of the electronic device may be Lenovo Xiaotian or Lenovo AI NOW, etc.

In some other embodiments, the target intelligent agent may also be a virtual assistant in the electronic device that is able to be applied to different applications, or a virtual assistant specially set up for each application to match the application. Virtual assistants for different applications may be used to express the user's operating status of the applications in real time or help the user control the applications to achieve operations that meet the user's intentions. For example, a game assistant for a game application may be used to express a game player's game operation status in real time, and may also assist the player in setting up the game, changing the game character, changing the device mode, and performing different game experiences in the game.

In one embodiment, generative processing may be performed on the operating information of the electronic device. For example, the operating information of the electronic device may be input into a built-in generation model in the electronic device (the model may be a processing model embedded in the application for a specific application, or a model for various operations or applications in the electronic device) or an external cloud model for the generative processing. Therefore, the constituent elements of the target virtual image of the target intelligent agent may be obtained.

In one embodiment, for different operating information of the electronic device, the target intelligent agent may have different target virtual images or display forms. That is, the target intelligent agent may update the constituent elements (or components) of its virtual image in response to change(s) in operating information. Change(s) in operating information may include at least one of game progress for game applications, change(s) in operating application status for other applications, change(s) in application operating duration, or change(s) in application operating environment. The target virtual image may be a 3D virtual image or a 2D virtual image.

Exemplarily, when the target intelligent agent is a game assistant for a game application, such as Lenovo's gaming zone virtual assistant, the operating information may include at least one of: game progress, game highlights, item acquisition, game battle results, game duration, game mode, game scene, or game type. Based on this, the change(s) of the operating information may include at least one of change(s) in game progress, change(s) in game operation state, change(s) of game operating duration, change(s) of game scene/environment, change(s) of item acquisition, or change(s) of game highlight moment.

Exemplarily, for a game application, when the operating information may include highlight moments and item acquisition, after the operating information including the highlight moments and item acquisition is generated and processed, the constituent elements such as hats or weapons used to celebrate the highlight moments may be obtained, then the hat may be worn on the virtual image or output interface of the target intelligent agent, and props similar to the weapon may be held by hand. For a conference application, when the operating information may include information indicating that a meeting is in progress and information indicating that the electronic device is outdoors, after the conference content is generated and processed, the constituent elements such as computer pendants or outdoor backgrounds may be obtained, and then the background of the target intelligent agent may be updated to an outdoor background or a computer pendant may be carried.

In the present disclosure, the target virtual image of the target intelligent agent may change with the change of the operating information of the electronic device, which improves the flexibility and real-time performance of the target virtual image, and also enhances the interactivity between the user and the operating application.

In some embodiments, S101 may include at least one of:
in response to the electronic device enabling the target intelligent agent, using the target intelligent agent to monitor the operating application information of the electronic device;
in response to obtaining the configuration operation acting on the target interface of the electronic device, obtaining the operating configuration information generated by the configuration operation;
based on at least one sensor, obtaining the operating environment information of the electronic device, where the at least one sensor belongs to or does not belong to the electronic device; or
monitoring the operating parameters of the target component of the electronic device and obtaining the operating information of the electronic device based on the operating parameters.

In one embodiment, when the target intelligent agent is the virtual assistant of the electronic device, the target intelligent agent of the electronic device may be enabled, and the target intelligent agent may monitor the operating application information of the currently operating application. Or, when the target intelligent agent is the virtual assistant that is applied to different applications in the electronic device, the target intelligent agent of a certain application may be enabled, and the target intelligent agent may monitor the operating application information of the application. The operating application information may include at least one of the following: the application type, the application operating duration, the application output content, or the associated props or equipment, or other associated elements.

Exemplarily, when the target intelligent agent monitors the operating application information of the game application, the operating application information may include at least one of the following: game duration, item equipment acquisition, game progress, game highlights, game battle results, game scenes, or game types.

Exemplarily, when a game player obtains a powerful weapon in the game, the target intelligent agent, i.e., the game assistant, may use the powerful weapon as the obtained operating information of the electronic device. For example, the powerful weapon may be used to generate and process a prop similar to the weapon, and the prop may be added to the virtual image of the game assistant. When the game player obtains a highlight moment at a certain game level, the target intelligent agent may process the highlight moment into a dressing element, such as a hat, and wear the hat on the head of the virtual image generated by the game assistant for the player to celebrate.

In one embodiment, the target interface may be an interface of the operating application. The configuration operation of the target interface may be the configuration of certain components or parts on the target interface by the user.

Exemplarily, for the game application, the configuration operation of the target interface may be a configuration operation for the game mode, player role, player type, etc. That is, the operating configuration information may include at least one of the following: game mode, player role, or player type. For other applications such as image generation applications, social applications, or conference applications, the configuration operation of the target interface may be the configuration of output parameters or output methods. That is, the operating configuration information may include at least one of the following: output parameters or output methods.

Exemplarily, for a game application, when the game mode is a multiplayer mode, the virtual image corresponding to the target intelligent agent may wear a logo of a team to which the player belongs. When the game mode is a single-player mode, the target virtual image of the target intelligent agent may be an image that matches the player's character, such as the appearance or style of the character. When the player character is a female player, the target virtual image of the target intelligent agent may be related to women, such as female clothing or female headdress. When the player character is a male player, the target virtual image of the target intelligent agent may be related to men, such as male clothing or male headdress. When the player type is a novice player, the target virtual image of the target intelligent agent may be a kind, friendly, and approachable image. When the player type is an experienced player, the target virtual image of the target intelligent agent may be a cool, unique or technological image.

Exemplarily, for the image generation application, the output parameter included in the operating configuration information may be the currently generated image, and the target intelligent agent may carry a small image of the currently generated image.

In one embodiment of the present disclosure, the operating environment information may be the environmental information of the surrounding environment of the electronic device obtained by using a sensor provided by the electronic device or an external sensor. Based on the environmental information of the surrounding environment of the electronic device, the target virtual image of the target intelligent agent of the electronic device may be configured such that the target virtual image is able to adapt to the current environment.

Exemplarily, when the operating environment information of the electronic device indicates that it is in an amusement park, the constituent elements of its target virtual image may include cartoon pendants, cartoon clothing, etc. When the operating environment information of the electronic device indicates that it is located in a school campus, the constituent elements of its target virtual image may include school-related pendants. When the operating environment information of the electronic device indicates that it is in a cold environment/hot environment, the constituent elements of its target virtual image may include warm clothing/light clothing.

In one embodiment of the present disclosure, the operating parameters of the target component of the electronic device may be monitored through a driver interface, an API interface or other interface, and the operating information of the electronic device may be obtained based on the operating parameter information. The target component may include a hardware component and a software component. The hardware component may include at least one of the following: processor, memory, or fan, and the corresponding operating parameters may include at least one of the following: processor occupancy, memory occupancy, or fan speed. Based on at least one of the processor occupancy, memory occupancy, or fan speed, it may be determined which mode the electronic device is currently in, such as performance mode or silent mode, that is, the operating information of the hardware components. The software component may be a software application, and the corresponding operating parameter may be the operating state. The operating state may include at least one of the following: loading state, operating state, suspended state, or unloading state. The operating state may be the operating information of the software component.

Exemplarily, when the operating information of the electronic device is the performance mode, the constituent elements of the generated target virtual image may include elements for representing the performance mode, such as lightning, flames, or wings. When the operating information of the electronic device is the silent mode, the constituent elements of the generated target virtual image may include elements for representing the silent mode, such as clouds, feathers, “hush” gestures, silent symbols, or silent icons. When the operating information of the electronic device is in the loading state, the constituent elements of the generated target virtual image may include elements used to represent the loading state, such as rotating animation, looping animation, text prompts (such as “loading”), or icon prompts (such as hourglasses and rotating arrows). When the operating information of the electronic device is in the operating state, the constituent elements of the generated target virtual image may include elements used to represent the operating state, such as a little man that is always in an operating state or a virtual indicator light that is always flashing. When the operating information of the electronic device is in the suspended state, the constituent elements of the generated target virtual image may include elements used to represent the suspended state, such as a pause symbol or icon (such as a pattern with two slashes in a rectangular frame, or the word “pause”). When the operating information of the electronic device is in the uninstallation state, the constituent elements of the generated target virtual image may include elements used to represent the uninstallation state, such as a downward arrow or the word “uninstall”.

In some embodiments, S102 may include:
S201: generating and processing the obtained operating information of the electronic device using a target processing model to obtain at least one constituent element; and
S202: performing target processing on the at least one constituent element, such that the target intelligent agent of the electronic device has a target virtual image including the at least one constituent element.

The at least one constituent element may be used as the main element and/or the dressing element of the target virtual image.

The target intelligent agent may be the only intelligent agent on the electronic device or the intelligent agent that matches the current operating application of the electronic device.

In one embodiment, the target processing model may be a virtual image generation model integrated in the intelligent agent, or may be a virtual image generation model specially set in the electronic device.

In one embodiment, the operating information of the electronic device may be used as the input of the target processing model, and the at least one constituent element may be output.

In one embodiment, the target processing of the at least one constituent element may include at least one of the following: directly using the at least one constituent element as the target virtual image; or synthesizing the at least one constituent element as a dressing element onto the current virtual image or the initial virtual image.

In one embodiment, the main element may be understood as the main constituent element of the target virtual image. The dressing element may be understood as an element that plays an adaptive role. For example, when the virtual image is a person, the corresponding main element may be the various parts of the person, such as the head, arms, legs, etc.; the corresponding dressing element may be the clothing, accessories, pets, etc. of the person.

Exemplarily, for the game application, the operating information may include highlight moments and prop acquisition status. After the operating information including highlight moments or prop acquisition status is generated and processed by the target processing model, the constituent elements such as hats or weapons may be obtained. The hats may be worn on the target intelligent agent, and props similar to the weapons may be held.

In some embodiments, performing the target processing on the at least one constituent element such that the target intelligent agent of the electronic device has the target virtual image including the at least one constituent element may include at least one of:
when the target intelligent agent has a virtual image, performing synthesizing processing on the at least one constituent element as a dressing element with the current virtual image of the target intelligent agent, such that the target intelligent agent has the target virtual image including the dressing element;
when the target intelligent agent does not have a virtual image, using the at least one constituent element respectively used as the main element or the dressing element to form the target virtual image of the target intelligent agent based on the categories of each of the at least one constituent element and/or the association relationship between each of the at least one constituent element; or
when the target intelligent agent does not have a virtual image, processing the at least one constituent element to generate a virtual image to obtain the target virtual image of the target intelligent agent.

In the present disclosure, it may be determined whether the target intelligent agent has a virtual image. In the case where the target intelligent agent has a virtual image, the at least one constituent element as a dressing element may be superimposed on the current virtual image (i.e., the two may be synthesized) to obtain the target virtual image.

For example, for the game application, when a weapon is obtained, the weapon may be processed into a corresponding assembly element, and the weapon element may be added to the corresponding position on the basis of the current virtual image to obtain the target virtual image of the target intelligent agent. When a highlight moment is obtained, the generated dressing element representing the highlight moment, such as a hat, may be worn on the target intelligent agent on the basis of the current virtual image to obtain the target virtual image of the target intelligent agent.

In one embodiment, in the case where the target intelligent agent does not have a virtual image, based on the category of each of the at least one constituent element and/or the association relationship between each of the at least one constituent element, one of the at least one constituent element as the main element and one of the at least one constituent element as the dressing element may be determined to constitute the target virtual image of the target intelligent agent as a whole.

Exemplarily, for the game application, when the game scene included in the operating information is a glacier scene and the prop acquisition situation included is the acquisition of a weapon, the at least one constituent element may include warm clothing and a weapon, which belong to the clothing category and the pendant category respectively. Therefore, the warm clothing may be used as the main element and the weapon may be used as the dressing element. And then the warm clothing may be worn on the virtual image of the target intelligent agent, and the weapon may be held or carried by the virtual image of the target intelligent agent, thereby obtaining the target virtual image. When the operating information may include the prop acquisition situation and the highlight moment, the at least one constituent element may include the acquired prop such as the weapon and the scarf used to celebrate the highlight moment, both of which belong to the pendant category, i.e., the dressing element. The scarf may be usually wrapped around the neck, and the weapon may be usually held in hand. Therefore, the scarf may be wrapped around the neck of the virtual image of the target intelligent agent, and the virtual image of the target intelligent agent may hold the weapon, thereby obtaining the target virtual image.

In one embodiment of the present disclosure, when the target intelligent agent does not have a virtual image, the target processing model may be used to perform virtual image generative processing on the at least one constituent element to obtain the target virtual image adapted to the game player.

For example, for the game application, when the at least one component may include clothing, hat, and hairstyle, the target processing model may be used to generate virtual images for the clothing, the hat, and the hairstyle. For example, the clothing, hat, and hairstyle suitable for the game player may be generated in combination with the preferences of the game player and game scene, and applied to the target intelligent agent. For example, when the game player is a female who likes long hair and the game scene is a cartoon scene, the generated clothing may be cartoon clothing, the hat may be a cartoon hat, and the hairstyle may be long hair, and the target virtual image suitable for the game player may be obtained. When the game player is a female who likes short hair and the game scene is an action-adventure scene, the generated clothing may be neutral and handsome clothing, the hat may be a capable hat such as a peaked cap, and the hairstyle may be short hair, and the target virtual image suitable for the game player may be obtained.

In some embodiments, configuring the target intelligent agent of the electronic device to have the target virtual image based on the operating information may include at least one of:

Using variable parameters of the operating information to update the current virtual image of the target intelligent agent of the electronic device such that the target intelligent agent has the target virtual image, wherein the constituent elements of the target virtual image may be different from the current virtual image, and/or the functions and/or services that the target virtual image may provide may be different from the current virtual image; or
obtaining the usage change information of the electronic device, and configuring the target intelligent agent of the electronic device to have the target virtual image based on the usage change information and the operating information.

In one embodiment of the present disclosure, the variable parameters of the operating information may be understood as parameters of the operating information that change during the operation of the electronic device. For example, the variable parameters may be switching from application A to application B, or switching from game category C to game category D, or switching from game mode 1 to game mode 2, or entering game level 4 from game level 3, etc.

Exemplarily, when the variable parameters of the operating information indicate that the game player has conquered a game level and won a highlight moment, on the basis of the original virtual image, the background or pendant (such as a weapon) corresponding to the highlight moment may be added. When the variable parameters of the operating information indicate switching from a game application to a conference application, the equipment and/or pendant of the game application constituting the virtual image may be updated to the equipment and/or pendant of the conference application, or the game intelligent agent used by the game application may be switched to the virtual image of the conference assistant corresponding to the conference application, or the game player image of the agent corresponding to the game application may be switched to the conference assistant image of the corresponding agent of the conference application. When the variable parameters of the operation parameter indicate switching from a single-player game mode to a multiplayer game mode, the pendant representing a single person and constituting the virtual image may be updated to a pendant representing multiple people.

In one embodiment of the present disclosure, the functions and/or services that the target virtual image may provide may be different from those of the current virtual image. It may be understood that the functions and/or services that the corresponding virtual image may provide may be different for different variable parameters of the operating information.

For example, for different applications, the virtual image corresponding to the game application may provide the functions of artificial intelligence coach and companion play, or the virtual image corresponding to the live broadcast application or conference application may provide guidance or explanation functions.

The usage change information of the electronic device may be understood as the change information generated during the user's use of the electronic device. For example, the usage change information may include the usage object change information (such as switching from user A to user B), the usage scene change information (such as switching from the game scene to the conference scene or the audio-visual scene), the usage environment change information (such as switching from the outdoor scene to the indoor scene, or from the company scene to the home scene), etc.

In one embodiment of the present disclosure, after the usage object, the usage scene or the usage environment change(s), the virtual image of the target intelligent agent may be updated based on the changed object, the changed scene or the changed environment, combined with the operating information of the electronic device, to obtain the target virtual image adapted to the current object, the current scene or the current environment.

For example, when the change information indicates switching from an outdoor scene to an indoor scene, and the operating information indicates that the operating application is a game application, the background of the target virtual image of the game intelligent agent (i.e., the target intelligent agent) may be switched from an outdoor background to an indoor background. When the change information indicates switching from a male object to a female object, and the operating information indicates that the operating application may be a game application, the game virtual image representing the male of the target intelligent agent may be updated to the game virtual image representing the female. When the change information indicates switching from a game scene to an audio-visual scene, and the operating information indicates switching from a game application to an audio-visual application, the virtual image representing the game of the target intelligent agent may be updated to the virtual image representing the audio-visual. The virtual image representing the game may be a game player character, and the virtual image representing the audio-visual may be a character or projection pendant that matches the current movie, TV series, or cartoon.

In some embodiments, configuring the target intelligent agent of the electronic device to have the target virtual image based on the operating information may include at least one of the following:
performing the generative processing on the obtained operating application information of the electronic device to obtain the dressing element of the target intelligent agent, and synthesizing the dressing element with the current virtual image of the target intelligent agent, such that the target intelligent agent has the target virtual image including the dressing element;
performing the generative processing on the obtained operating mode information of the electronic device to obtain the dressing element or the element to be updated of the target intelligent agent, and using the dressing element or the element to be updated to update the current virtual image of the target intelligent agent, such that the target intelligent agent has the target virtual image that matches the current operating mode of the electronic device; or
performing the generative processing on the obtained operating environment information of the electronic device to obtain the dressing element or the element to be updated of the target intelligent agent, and using the dressing element or the element to be updated to update the current virtual image of the target intelligent agent, such that the target intelligent agent has the target virtual image that matches the current operating environment of the electronic device.

The target intelligent agent may be the only intelligent agent on the electronic device or an intelligent agent that matches the currently operating application of the electronic device.

In one embodiment of the present disclosure, the operating information may include operating application information, and the operating application information may be understood as the application information generated by the operating application during the operating process. For example, the operating application information may include at least one of the following: application name, application type, application progress, highlight moment, or application-specific elements. The highlight moment may be a display interface of a specific application, such as a game application. When conquering a game level, a pendant representing the highlight moment is won for display.

In one embodiment of the present disclosure, the operating application information of the electronic device may be generated and processed using the processing model built into the target intelligent agent to obtain the dressing element of the target intelligent agent. Alternatively, the operating application information of the electronic device may be generated and processed using the processing model of the electronic device to obtain the dressing element of the target intelligent agent.

In one embodiment of the present disclosure, the dressing element may be synthesized with the current virtual image of the target intelligent agent, which may be understood as adding the dressing element to the corresponding part or specific position of the current virtual image according to the pre-set synthesis logic. For example, the position and display parameters of the dressing element in the current virtual image may be determined based on the type and/or source of the dressing element. The current virtual image may be the default virtual image or the initial virtual image of the target intelligent agent.

Exemplarily, when the dressing element is a weapon, the hand position of the weapon in the current virtual image may be determined, and a prop similar to the weapon at the hand position may be displayed. When the dressing element is a hat, the head position of the hat in the current virtual image may be determined to display a prop similar to the hat at the head position. When the dressing element is a boot, the foot position of the boot in the current virtual image may be determined to display a prop similar to the boot at the foot position. When the dressing element is a hat and comes from a game application, the head position of the hat in the current virtual image may be determined to display a prop that matches the game and may be similar to the hat at the head position. When the dressing element is glasses and comes from a conference application, the eye position of the glasses in the current virtual image may be determined to display a prop that matches the conference and may be similar to or related to the glasses at the head position.

In one embodiment of the present disclosure, the operating information also may include operating mode information, and the operating mode information may be understood as the mode information of the operating application. For example, the operating mode information may include at least one of the following: performance mode, silent mode, balance mode, audio/video mode, game mode, conference mode, or noise reduction mode.

Exemplarily, the performance mode may be generated and processed to generate a dressing element or an element to be updated that may represent the performance mode, such as adding a fan pendant or various beast image pendants/accessories on the basis of the original virtual image. The silent mode may be generated and processed to generate dressing elements or elements to be updated that may represent the silent mode, such as adding a headphone pendant or a mute button icon on the basis of the original virtual image. The balance mode may be generated and processed to generate dressing elements or elements to be updated that may represent the balance mode, such as adding a skateboard pendant or a balance symbol (such as a Tai Chi diagram, a Yin-Yang fish) on the basis of the original virtual image. The audio/video mode may be generated and processed to generate dressing elements or elements to be updated that may represent the audio/video mode, such as adding a projection pendant on the basis of the original virtual image, or character pendants or costumes related to TV series/movies/cartoons. The game mode may be generated and processed to generate dressing elements or elements to be updated that may represent the game mode, such as game character pendants, game character costumes, pendants related to game scenes, or pendants related to game modes (such as single-player mode, multiplayer mode) on the basis of the original virtual image. The conference mode may be generated and processed to generate dressing elements or elements to be updated that may represent the conference mode, such as a conversation icon or a “do not disturb” icon based on the original virtual image. The noise reduction mode may be generated and processed to generate dressing elements or elements to be updated that may represent the noise reduction mode, such as a pendant wearing headphones, a noise reduction sponge/foam pendant, or a wavy line icon representing that the sound may be weakened based on the original virtual image.

In one embodiment of the present disclosure, the elements to be updated may be elements that already exist in the original virtual image but may be different. The main element in the current virtual image may be updated using the elements to be updated, such as the mouth state, theme color, and clothing style of the target intelligent agent. The dressing elements in the current virtual image may also be updated using the elements to be updated, such as the microphone state, handheld pendant, and fan state.

In one embodiment of the present disclosure, the current virtual image of the target intelligent agent may be updated using the dressing elements or the elements to be updated, which may be understood as replacing or adding constituent elements in the current virtual image.

Exemplarily, the game mode may be generated and processed, and the target intelligent agent's dressing elements such as game character pendants and elements to be updated such as game costumes may be obtained. Then the current virtual image's costumes may be updated to game costumes, and game character pendants may be added to the current virtual image, such that the target intelligent agent has the target virtual image that matches the game mode. The conference mode may be generated and processed, and the target intelligent agent's dressing elements such as dialogue icons and elements to be updated such as theme colors may be obtained. Then the theme color of the current virtual image may be updated to be related to the conference, and dialogue icons may be added to the current virtual image, such that the target intelligent agent has the target virtual image that matches the conference mode. The silent mode may be generated and processed, and the target intelligent agent's dressing elements such as wearing headphones may be obtained, and headphones may be worn on the current virtual image, such that the target intelligent agent has the target virtual image that matches the silent mode.

In an embodiment of the present disclosure, the operating information may also include operating environment information, which may be understood as information about the surrounding environment of the electronic device. For example, the operating environment information may include at least one of the following: object information in the spatial environment (such as crowded or not crowded, indoors or outdoors), ambient brightness, ambient color temperature, or ambient noise.

Exemplarily, when the operating environment information may include ambient brightness, the dressing element or the element to be updated of the target intelligent agent may include a light-on state pendant or a light-off state pendant. When the operating environment information may include ambient noise, the dressing element or the element to be updated of the target intelligent agent may include a headphone pendant or a noise reduction sponge/foam pendant. When the object information in the spatial environment included in the operating environment information indicates that there may be few people, the dressing element or the element to be updated of the target intelligent agent may include a puppet pendant. When the object information in the spatial environment included in the operating environment information indicates that there may be many people, the dressing element or the element to be updated of the target intelligent agent may include multiple puppet pendants. When the object information in the spatial environment included in the operating environment information indicates an indoor environment, the dressing element or the element to be updated of the target intelligent agent may include a family photo pendant or a furniture pendant. When the object information in the spatial environment included in the operating environment information indicates an outdoor environment, the target intelligent agent's dressing element or element to be updated may include landmark building pendants or green plant pendants related to the current outdoor environment. Further, the target intelligent agent's dressing element or element to be updated may be used to replace or add constituent elements in the current virtual image, such that the target intelligent agent has the target virtual image that matches the current operating environment of the electronic device.

In one embodiment of the present disclosure, the target intelligent agent may be the only intelligent agent configured for the electronic device, or different intelligent agents configured for different applications.

In some embodiments, performing the generative processing on the obtained operating application information of the electronic device to obtain the dressing element of the target intelligent agent, may include at least one of the following:
performing the generative processing on the obtained application category or application name of the currently operating application of the electronic device to obtain the dressing element matching the application category or the application name, where dressing elements corresponding to different application categories may be different;
performing the generative processing on the obtained target window content and/or target object element of the currently operating application of the obtained electronic device to obtain the dressing element matching the target window content and/or the target object element, where dressing elements corresponding to different target window contents may be different and/or dressing elements corresponding to different target object elements may be different;
in the case where the application currently operating on the electronic device is a game application, generating the dressing element of the target intelligent agent corresponding to the game application based on the game progress information and/or target props equipment information of the game application, where the target props equipment information may be the props equipment information of the target player; or
obtaining the historical data of the currently operating application of the electronic device, and updating the target dressing element of the target intelligent agent based on the historical data to obtain the target virtual image matching the historical data.

In one embodiment of the present disclosure, the operating application information may be understood as the application information generated by the operating application during the operating process. For example, the operating application information may include at least one of the following: application name, application type, application progress, highlight moment, or application-specific elements.

In one embodiment of the present disclosure, the target processing model built into the target intelligent agent or the target processing model of the electronic device may be used to perform the generative processing on the application category or application name of the currently operating application of the electronic device to obtain the dressing element that matches the application category or application name.

Exemplarily, when the application category of the currently operating application of the electronic device is a game application, or the application type is identified as a game application based on the application name of the currently operating application of the electronic device, the dressing element may be a dressing element that matches the game. For example, the dressing element may include a game character pendant, a game character costume, or a game mode pendant. When the application category of the currently operating application of the electronic device is an audio-video application, the dressing element may be a dressing element that matches the audio-video. For example, the dressing element may include a projection pendant. When the application category of the currently operating application of the electronic device is a shopping application, the dressing element may be a dressing element that matches shopping. For example, the dressing element may include a shopping cart pendant.

In one embodiment of the present disclosure, the target window content may be understood as the content in the target window of the application interface of the currently operating application. For example, for a game application, the player may conquer a game level and win a highlight moment. At this time, the content of the highlight moment may be the target window content. For a chat application, the target window content may be the content included in a specific area of the chat application's application interface, or the chat content with a specific object. For a conference application, the target window content may be the content included in the entire application interface of the conference application.

In one embodiment of the present disclosure, the target object element may include at least one of the following: specific controls, display objects, or charts in the application interface. For example, for the game application, the target object element may include at least one of the following: equipment, props (i.e., display objects) of game players, or avatar information of avatar controls (i.e., specific controls). For the conference application, the target object element may include charts or text information displayed in the application interface.

Exemplarily, for the game applications, when the target window content is the content of the highlight moment, the target object element may include the equipment, props or avatar information of the game player. Generative processing may be performed on the content of the highlight moment to obtain flowers for celebrating the highlight moment, and generative processing may be performed on the equipment, props and avatar information of the game player to obtain a battle suit matching it. And then the clothing of the target intelligent agent may be updated to the battle suit, and flowers may be held in hand. For the conference application, when the target window content indicates that a conference discussion is in progress, a “do not disturb” icon or an icon for representing the image of the conference may be generated and added to the original virtual image, and the target virtual image may be obtained.

In one embodiment of the present disclosure, the game progress information may refer to the level of the game.

Exemplarily, when the game progress information indicates that the game is at level 3, the corresponding dressing element may be an icon or text information used to represent level 3. When the target item equipment information indicates that the game player obtains equipment and/or an item, the corresponding dressing element may be a costume or accessory similar to the equipment, and/or a pendant or accessory similar to the item.

In one embodiment of the present disclosure, the historical data of the currently operating application of the electronic device may be understood as the data generated by the user in the process of operating the application at a historical moment.

Exemplarily, for the game application, the historical data of the currently operating application of the electronic device may be the operating data of the player of the previous game or the usage mode data of the game assistant, and the usage mode may include the role mode or the game mode. For example, when the role of the game assistant in the previous game is an artificial intelligence coach, the displayed virtual image may be updated to an image or element that may represent the identity or identification of the coach. When the role of the game assistant in the previous game is a player character, the displayed virtual image may be updated to an image or element that may represent the identity or identification of the player character. For the shopping application, the historical data of the currently operating application of the electronic device may be the last shopping data. For example, based on the last shopping data, the virtual image may be updated to an image or element that may represent the shopping content.

In some embodiments, the method may include at least one of the following:
based on the obtained operating application information of the electronic device,
determining the display area and/or display mode of the target virtual image, to display the target virtual image in the determined display area through the determined display mode; or
based on the variable parameters of the operating information, updating the display area and/or display mode of the target virtual image.

In one embodiment of the present disclosure, the operating information of the electronic device may include operating application information, and the operating application information may be understood as the information generated by the operating application during the operating process. The operating application information may include at least one of the following: foreground operating state or background operating state.

For example, for the game application, the operating application information may include at least one of the following: game in progress, game exit, game switched to the background (or called pause state, hosting state). For the conference application, the operating application information may include at least one of the following: conference in progress, conference ended, or conference switched to the background.

In one embodiment of the present disclosure, the display area may include at least one of the following: the display area of the application window or the display area of the desktop window. For example, the display area may include at least one of the following: the upper left corner area, the lower left corner area, the upper right corner area, or the lower right corner area.

In one embodiment of the present disclosure, the display mode may include at least one of the following: floating display, tiled display, embedded display, static display, or dynamic display.

For example, for the game application, when the operating application information indicates that the game is in progress, the virtual image may be dynamically displayed in the upper left corner area of the game application window. When the operating application information indicates that the game is switched to the background, the virtual image may be statically displayed in the upper left corner area of the desktop window. When the operating application information indicates that the game is over, the virtual image may be tiled and displayed in the upper left corner area of the desktop window. For the conference application, when the operating application information indicates that the conference is in progress, the virtual image may be embedded and displayed in the lower left corner area of the conference application window. When the operating application information indicates that the conference is switched to the background, the virtual image may be suspended and displayed in the lower left corner area of the desktop window. When the operating application information indicates that the conference is over, the virtual image may be statically displayed in the lower left corner area of the desktop window.

In one embodiment of the present disclosure, the variable parameter of the operating information may be understood as the parameter of the operating information that change(s) during the operation of the electronic device. For example, the variable parameter may be switching from application A to application B, or switching from game category C to game category D, or switching from game mode 1 to game mode 2, or entering game level 4 from game level 3, etc.

In the embodiment of the present disclosure, after the operating information change(s), the display area and/or display mode of the virtual image may be dynamically adjusted.

For example, when the variable parameter indicates switching from application A to application B, the display area of the virtual image of application A may be the upper left corner of the application window, the display mode of the virtual image of application A may be dynamic display, the display area of the virtual image of application B may be the lower left corner of the application window, and the display mode of the virtual image of application B may be static display. Therefore, after application A switches to application B, the display area of the virtual image may be updated to the lower left corner of the application window, and the display mode may be updated to static display. When the variable parameter indicates switching from game mode 1 to game mode 2, the display area of the virtual image corresponding to game mode 1 may be the upper right corner of the application window, and the display mode may be floating display, while the display area of the virtual image corresponding to game mode 2 may be the lower right corner of the application window, and the display mode may be tiled display. Therefore, after game mode 1 switches to game mode 2, the display area of the virtual image may be updated to the lower right corner of the application window, and the display mode may be updated to tiled display.

In some embodiments, S102 may include:
S301: when the electronic device runs a game application, obtaining player data of the game application, where the player data includes player operation data and/or player account data;
S302: updating the dressing elements and/or main elements of the game intelligent agent corresponding to the game application based on the player data and the target game data of the game application, such that the game intelligent agent has a game virtual image that matches the player data and the target game data.

In one embodiment of the present disclosure, for the game application, the operating information may include the player data and target game data. The player data may be data that may characterize the player's status, and may include at least one of the following: equipment information, level information, prop information, experience value, account category (including VIP, gold, platinum level), or highlight moment. The equipment information, prop information, and highlight moment may belong to the player operation data of the game player during the game process, and the level information, experience value, and account category may belong to the player account data.

In one embodiment of the present disclosure, the target game data may be data related to the game itself, which may include at least one of the following: game scene, game level, game map, game screen, game mode, game battle result, game duration, or game progress.

In one embodiment of the present disclosure, the game intelligent agent may be a game virtual assistant.

In one embodiment of the present disclosure, the target processing model built into the game intelligent agent or the target processing model of the electronic device may be used to perform generative processing on the player data and the target game data of the game application, to obtain the dressing elements and/or main elements of the game intelligent agent, such that the game intelligent agent has a game virtual image that matches the player data and the target game data.

For example, when the player data indicates that the player account is a gold account and the target game data indicates that a game level is conquered, the constituent elements of the virtual image of the game intelligent agent may include a gold crown and a bouquet of flowers, and it may be determined that the gold crown and a bouquet of flowers belong to the dressing elements. And then the gold crown may be worn on the head of the game intelligent agent, and the game intelligent agent may hold flowers. When the player data indicates that the player obtains a weapon and the target game data indicates that the game scene is a cartoon scene, the constituent elements of the game intelligent agent may include props and cartoon costumes similar to the weapon, and it may be determined that the props similar to the weapon belong to the dress-up elements and the cartoon costumes belong to the main elements. And then the costumes of the game intelligent agent may be updated to cartoon costumes, and the game intelligent agent may hold props similar to the weapon. When the player data indicates that the player level is level 6 and the target game data indicates that the game level is level 3, the constituent elements of the game intelligent agent may include a first icon for representing the player's level 6 and a second icon for representing game level 3, and it may be determined that the first icon and the second icon belong to the dressing elements. And then the first icon and the second icon may be carried on the game intelligent agent. When the player data indicates that the player conquers the game level and wins the highlight moment and the target game data indicates that the game map is a desert map, the constituent elements of the game intelligent agent may include a hat for celebrating the highlight moment and a pendant for representing the desert map, such as a sand dune, and it may be determined that the hat and the sand dune belong to the dressing elements. And then the hat may be carried on the head of the game intelligent agent, and the sand dune pendant may be hung on the game intelligent agent.

It should be noted that, before using the target processing model, it may be necessary to collect a large amount of historical player data and historical game data, as well as corresponding dressing samples, to train the initial processing model such that it may accurately generate appropriate constituent elements based on the player data and target game data. Deep learning or other technologies may be used to continuously optimize the performance of the algorithm.

In addition, it may be possible to cooperate with game developers or implement the above-mentioned interactive processing method by developing plug-ins, etc., to ensure that the player data and target game data of game applications may be obtained in real time, and the constituent elements of the corresponding virtual image may be generated and then displayed in the game interface.

In this way, the automatic dressing of the game intelligent agent may be realized without manual operation by the player, which greatly improves the fun and immersion of the game and enhances the connection between the player and the game.

Based on the above embodiments, one embodiment of the present disclosure takes the game application as an example and provides an interactive processing method. FIG. 4 is a flow chart of the interactive processing method in the present embodiment. As shown in FIG. 4, the interactive processing method includes:

S401: obtaining the player data of the game application, where the player data includes the player operation data and/or the player account data;

S402: performing generative processing on the player data and the target game data of the game application using the target processing model to obtain at least one constituent element and form the game virtual image of the game intelligent agent; and

S403: performing target processing on the at least one constituent element to update the dressing element and/or the main element of the game agent, such that the game intelligent agent has a game virtual image that matches the player data and the target game data.

In this way, the automatic dressing of the game intelligent agent may be realized without manual operation by the player, which greatly improves the fun and immersion of the game and enhances the connection between the player and the game.

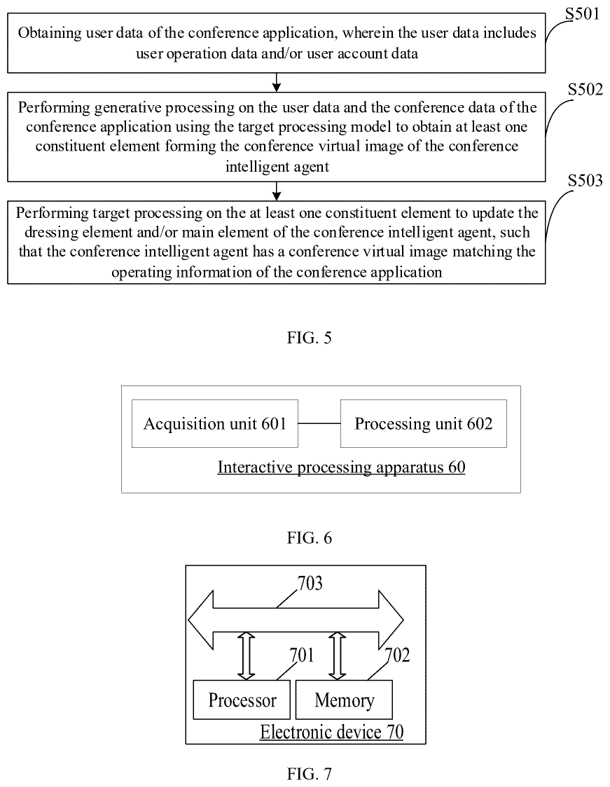

Based on the above embodiments, one embodiment of the present disclosure takes the conference application as an example and provides an interactive processing method. FIG. 5 is a flowchart of the interactive processing method in the present embodiment. As shown in FIG. 5, the interactive processing method includes:

S501: obtaining user data of the conference application, wherein the user data includes user operation data and/or user account data;

S502: performing generative processing on the user data and the conference data of the conference application using the target processing model to obtain at least one constituent element forming the conference virtual image of the conference intelligent agent; and

S503: performing target processing on the at least one constituent element to update the dressing element and/or main element of the conference intelligent agent, such that the conference intelligent agent has a conference virtual image matching the operating information of the conference application.

In this way, the automatic dressing of the conference intelligent agent can be realized without manual operation by the user, which greatly improves the fun and immersion of the meeting and enhances the connection between the user and the conference application.

The present disclosure also provides an interactive processing apparatus to implement any interactive processing method provided by various embodiments of the present disclosure. FIG. 6 is a schematic diagram of the structure of the interactive processing apparatus provided by one embodiment of the present disclosure. As shown in FIG. 6, in one embodiment, the interactive processing apparatus 60 includes:
an acquisition unit 601, configured to obtain the operating information of the electronic device; and
a processing unit 602, configured to configure the target intelligent agent of the electronic device to have a target virtual image based on the operating information.

The target intelligent agent may update the constituent elements of a virtual image thereof in response to the change of the operating information.

In one embodiment of the present disclosure, the target virtual image of the target intelligent agent may be configured to change with the change of the operating information of the electronic device, thereby improving the flexibility and real-time performance of the target virtual image and enhancing the interactivity between the user and the operating application.

In some embodiments, the acquisition unit 601 may also be configured to:
in response to the electronic device enabling the target intelligent agent, use the target intelligent agent to monitor the operating application information of the electronic device;
in response to obtaining the configuration operation acting on the target interface of the electronic device, obtaining the running configuration information generated by the configuration operation;
obtaining the operating environment information of the electronic device based on at least one sensor, where the at least one sensor belongs to or does not belong to the electronic device; or
monitoring the operating parameters of the target component of the electronic device, where the operating information of the electronic device is obtained based on the operating parameters.

In some embodiments, the processing unit 602 may be also used to: perform generative processing on the obtained operating information of the electronic device using the target processing model to obtain the at least one constituent element; and perform target processing on the at least one constituent element such that the target intelligent agent of the electronic device has a target virtual image including the at least one constituent element. The at least one constituent element may serve as the main element and/or the dressing element of the target virtual image. The target intelligent agent may be the only intelligent agent on the electronic device or the intelligent agent that matches the currently operating application of the electronic device.

In some embodiments, the processing unit 602 may be further configured to:
when the target intelligent agent has a virtual image, use the at least one constituent element as the dressing element which is synthesized with the current virtual image of the target intelligent agent, such that the target intelligent agent has the target virtual image including the dressing element;
when the target intelligent agent does not have a virtual image, use the at least one constituent element as the main element and dressing element respectively based on the categories of the at least one constituent element and/or the associations between the at least one constituent element to form the target virtual image of the target intelligent agent; or
when the target intelligent agent does not have a virtual image, perform generative processing on the at least one constituent element to generate a virtual image and obtain the target virtual image of the target intelligent agent.

In some embodiments, the processing unit 602 may be further configured to:
use the variable parameter of the operating information to update the current virtual image of the target intelligent agent of the electronic device, such that the target intelligent agent has a target virtual image, the constituent element of the target virtual image is different from the current virtual image, and/or the functions and/or services that the target virtual image is able to provide are different from the current virtual image; or
obtain the usage change information of the electronic device, and configure the target intelligent agent of the electronic device to have the target virtual image based on the usage change information and the operating information.

In some embodiments, the processing unit 602 may be further configured to:
perform generative processing on the obtained operating application information of the electronic device to obtain the dressing element of the target intelligent agent, and synthesize the dressing element with the current virtual image of the target intelligent agent, such that the target intelligent agent has the target virtual image including the dressing element;
perform generative processing on the obtained running mode information of the electronic device to obtain the dressing element or the element to be updated of the target intelligent agent, and use the dressing element or the element to be updated to update the current virtual image of the target intelligent agent, such that the target intelligent agent has the target virtual image that matches the current running mode of the electronic device; or
perform generative processing on the obtained running environment information of the electronic device to obtain the dressing element or the element to be updated of the target intelligent agent, and use the dressing element or the element to be updated to update the current virtual image of the target intelligent agent, such that the target intelligent agent has the target virtual image that matches the current running environment of the electronic device.

The target intelligent agent may be the only one intelligent agent on the electronic device or an intelligent agent that matches the current operating application of the electronic device.

In some embodiments, the processing unit 602 may be further configured to:
perform generative processing on the application category or application name of the currently operating application of the obtained electronic device to obtain a dressing element matching the application category or the application name, where different application categories correspond to different dressing elements;
perform generative processing on the target window content and/or target object element of the currently operating application of the obtained electronic device to obtain a dressing element matching the target window content and/or the target object element, where different target window contents correspond to different dressing elements and/or different target object elements correspond to different dressing elements;
when the application currently running on the electronic device is a game application, generate a dressing element corresponding to the target intelligent agent of the game application based on the game progress information and/or target props equipment information of the game application, where the target props equipment information is the props equipment information of the target player; or
obtain the historical data of the currently operating application of the electronic device, and update the target dressing element of the target intelligent agent based on the historical data to obtain the target virtual image matching the historical data.

In some embodiments, the processing unit 602 may be further configured to:
determine the display area and/or display mode of the target virtual image based on the obtained operating application information of the electronic device, to display the target virtual image in the determined display area with the determined display mode; or
update the display area and/or display mode of the target virtual image based on the variable parameters of the operating information.

In some embodiments, the processing unit 602 may be further configured to: when the electronic device runs a game application, obtain the player data of the game application, where the player data includes the player operation data and/or the player account data; and update the dressing element and/or the main element of the game intelligent agent corresponding to the game application based on the player data and the target game data of the game application, such that the game intelligent agent has a game virtual image matching the player data and the target game data.

The present disclosure also provides an electronic device. FIG. 7 is a schematic diagram of the structure of the electronic device provided by one embodiment of the present disclosure. As shown in FIG. 7, in one embodiment, the electronic device 70 includes: processor(s) 701 and a memory 702 configured to store a computer program that is able to be executed on the processor(s).

When the processor 701 is configured to run the computer program, the processor 701 may execute any interactive processing method provided by various embodiments of the present disclosure.

As shown in FIG. 7, in one embodiment, various components in the electronic device 70 may be coupled together through a bus system 703. It can be understood that the bus system 703 is used to realize the connection and communication between these components. In addition to the data bus, the bus system 703 may also include a power bus, a control bus and a status signal bus. For the sake of clarity, various buses are marked as bus system 703 in FIG. 7.

In various embodiments, the processor may include at least one of an application specific integrated circuit (ASIC), a digital signal processing device (DSPD), a programmable logic device (PLD), a field programmable gate array (FPGA), a controller, a microcontroller, or a microprocessor. It can be understood that for different devices, the electronic device used to implement the above-mentioned processor function may also be other devices, which is not limited in the present disclosure.

The above-mentioned memory may include a volatile memory such as a random access memory (RAM); or a non-volatile memory such as a read-only memory (ROM), a flash memory, a hard disk (HDD) or a solid-state drive (SSD); or a combination of the above-mentioned types of memory, to provide instructions and data to the processor.

The present disclosure also provides a computer-readable storage medium for storing a computer program.

Optionally, the computer-readable storage medium may be used to implement any interactive processing method provided by various embodiments of the present disclosure, and the computer program may enable the computer to execute corresponding processes implemented by the processor in any interactive processing method provided by various embodiments of the present disclosure, which will not be repeated here for the sake of brevity.

The present disclosure also provides a computer program product, including a computer program which may be executed by a processor of an electronic device to make the electronic device implement any interactive processing method provided by various embodiments of the present disclosure.

It should be understood that the disclosed devices and methods can be implemented in other ways. The device embodiments described above are only schematic. For example, the division of the units is only a logical function division. There may be other division methods in actual implementation. For example, multiple units or components can be combined, or can be integrated into another system, or some features can be ignored, or not executed. In addition, the coupling, direct coupling, or communication connection between the components shown or discussed can be through some interfaces, and the indirect coupling or communication connection of the devices or units can be electrical, mechanical or other forms.

The units described above as separate components may or may not be physically separated, and the components shown as units may or may not be physical units. That is, they may be located in one place or distributed on multiple network units. Some or all of the units may be selected according to actual needs to achieve the purpose of the scheme of this embodiment.

In addition, all functional units in the embodiments of the present disclosure may be integrated into one processing module, or each unit can be used as a unit separately, or two or more units can be integrated into one unit. The above integrated unit can be implemented in the form of hardware or in the form of hardware plus software functional units. Those skilled in the art can understand that all or part of the steps of implementing the above method embodiments can be completed by hardware related to program instructions, and the above program can be stored in a computer-readable storage medium. When the program is executed, the steps of the above method embodiments are executed; and the above storage medium may include various media that can store program codes, such as mobile storage devices, read-only memory (ROM), random access memory (RAM), hard disks or optical disks, etc.

The methods disclosed in several method embodiments provided in this disclosure can be arbitrarily combined without conflict to obtain new method embodiments.

The features disclosed in several product embodiments provided in this disclosure can be arbitrarily combined without conflict to obtain new product embodiments.

The features disclosed in several method or device embodiments provided in this disclosure can be arbitrarily combined without conflict to obtain new method embodiments or device embodiments.

Various embodiments have been described to illustrate the operation principles and exemplary implementations. It should be understood by those skilled in the art that the present disclosure is not limited to the specific embodiments described herein and that various other obvious change(s), rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. An interactive processing method, comprising:
obtaining operating information of an electronic device; and
configuring a target intelligent agent of the electronic device to have a target virtual image based on the operating information, wherein the target intelligent agent is able to update constituent elements of a virtual image of the target intelligent agent in response to a change in the operating information.

2. The method according to claim 1, wherein obtaining the operating information of the electronic device includes at least one of:
in response to the electronic device enabling the target intelligent agent, using the target intelligent agent to monitor operating application information of the electronic device;
in response to obtaining a configuration operation acting on a target interface of the electronic device, obtaining operating configuration information generated by the configuration operation;
based on at least one sensor, obtaining operating environment information of the electronic device, wherein the at least one sensor belongs to or does not belong to the electronic device; or
monitoring an operating parameter of a target component of the electronic device, and obtaining the operating information of the electronic device based on the operating parameter.

3. The method according to claim 1, wherein:
configuring the target intelligent agent of the electronic device to have the target virtual image based on the operating information includes:
using a target processing model to perform generative processing on the operating information of the electronic device to obtain at least one constituent element;
performing target processing on the at least one constituent element such that the target intelligent agent of the electronic device has the target virtual image including the at least one constituent element,
wherein:
the at least one constituent element serves as a main element and/or a dressing element of the target virtual image; and
the target intelligent agent is the only intelligent agent on the electronic device or an intelligent agent that matches an application currently running on the electronic device.

4. The method according to claim 3, wherein:
performing the target processing on the at least one constituent element such that the target intelligent agent of the electronic device has the target virtual image including the at least one constituent element includes at least one of:
when the target intelligent agent has a virtual image, using the at least one constituent element as the dressing element and synthesizing the dressing element with the current virtual image of the target intelligent agent, such that the target intelligent agent has the target virtual image including the dressing element;
when the target intelligent agent does not have a virtual image, using the at least one constituent element as the main element and dressing element respectively to form the target virtual image of the target intelligent agent based on categories of the at least one constituent element and/or associations between the at least one constituent element; or
when the target intelligent agent does not have a virtual image, performing the generative processing on the at least one constituent element to generate a virtual image, to obtain the target virtual image of the target intelligent agent.

5. The method according to claim 1, wherein:
configuring the target intelligent agent of the electronic device to have the target virtual image based on the operating information includes at least one of:
using a variable parameter of the operating information to update the current virtual image of the target intelligent agent of the electronic device, such that the target intelligent agent has the target virtual image, wherein the constituent elements of the target virtual image are different from the current virtual image and/or functions and/or services that the target virtual image is able to provide are different from the current virtual image; or
obtaining usage change information of the electronic device, and configuring the target intelligent agent of the electronic device to have the target virtual image based on the usage change information and the operating information.

6. The method according to claim 1, wherein:
configuring the target intelligent agent of the electronic device to have the target virtual image based on the operating information includes at least one of:
performing generative processing on obtained operating application information of the electronic device to obtain a dressing element of the target intelligent agent, and synthesizing the dressing element with the current virtual image of the target intelligent agent, such that the target intelligent agent has the target virtual image including the dressing element;
performing generative processing on obtained operating mode information of the electronic device to obtain the dressing element or an element to be updated of the target intelligent agent, and updating the current virtual image of the target intelligent agent using the dressing element or the element to be updated, such that the target intelligent agent has the target virtual image that matches the current operating mode of the electronic device; or
performing generative processing on obtained operating environment information of the electronic device to obtain the dressing element or the element to be updated of the target intelligent agent, and updating the current virtual image of the target intelligent agent using the dressing element or the element to be updated, such that the target intelligent agent has the target virtual image that matches the current operating environment of the electronic device,
wherein, the target intelligent agent is the only intelligent agent on the electronic device or one intelligent agent that matches the current operation application of the electronic device.

7. The method according to claim 6, wherein:
performing the generative processing on the obtained operating application information of the electronic device to obtain the dressing element of the target intelligent agent, includes at least one of:
performing the generative processing on an obtained application category or application name of the currently operating application of the electronic device to obtain the dressing element matching the application category or the application name, wherein dressing elements corresponding to different application categories are different;
performing the generative processing on obtained target window content and/or target object elements of the currently operating application of the electronic device to obtain the dressing element matching the target window content and/or the target object elements, wherein dressing elements corresponding to different target window contents are different and/or dressing elements corresponding to different target object elements are different;
when the application currently operating on the electronic device is a game application, generating the dressing element of the target intelligent agent corresponding to the game application based on game progress information and/or target props equipment information of the game application, wherein the target props equipment information is props equipment information of a target player; or
obtaining historical data of the currently operating application of the electronic device and updating a target dressing element of the target intelligent agent based on the historical data to obtain the target virtual image matching the historical data.

8. The method according to claim 1, further including at least one of:
determining a display area and/or a display mode of the target virtual image based on the obtained operating application information of the electronic device, to display the target virtual image in the determined display area through the determined display mode; or
updating the display area and/or display mode of the target virtual image based on variable parameters of the operating information.

9. The method according to claim 1, wherein:
configuring the target intelligent agent of the electronic device to have the target virtual image based on the operating information includes:
when the electronic device runs a game application, obtaining player data of the game application, wherein the player data includes player operation data and/or player account data; and
based on the player data and the target game data of the game application, updating a dressing element and/or a main element of a game intelligent agent corresponding to the game application, such that the game intelligent agent has a game virtual image that matches the player data and the target game data.

10. An electronic device, comprising:
one or more processors; and
a memory containing a computer program that, when being executed, causes the one or more processors to perform:
obtaining operating information of the electronic device; and
configuring a target intelligent agent of the electronic device to have a target virtual image based on the operating information, wherein the target intelligent agent is able to update constituent elements of a virtual image of the target intelligent agent in response to a change in the operating information.

11. The device according to claim 10, wherein the one or more processors are further configured to perform at least one of:
in response to the electronic device enabling the target intelligent agent, using the target intelligent agent to monitor operating application information of the electronic device;
in response to obtaining a configuration operation acting on a target interface of the electronic device, obtaining operating configuration information generated by the configuration operation;
based on at least one sensor, obtaining operating environment information of the electronic device, wherein the at least one sensor belongs to or does not belong to the electronic device; or
monitoring an operating parameter of a target component of the electronic device, and obtaining the operating information of the electronic device based on the operating parameter.

12. The device according to claim 10, wherein the one or more processors are further configured to perform:
using a target processing model to perform generative processing on the operating information of the electronic device to obtain at least one constituent element;
performing target processing on the at least one constituent element such that the target intelligent agent of the electronic device has the target virtual image including the at least one constituent element,
wherein:
the at least one constituent element serves as a main element and/or a dressing element of the target virtual image; and
the target intelligent agent is the only intelligent agent on the electronic device or an intelligent agent that matches an application currently running on the electronic device.

13. The device according to claim 12, wherein the one or more processors are further configured to perform at least one of:
when the target intelligent agent has a virtual image, using the at least one constituent element as the dressing element and synthesizing the dressing element with the current virtual image of the target intelligent agent, such that the target intelligent agent has the target virtual image including the dressing element;
when the target intelligent agent does not have a virtual image, using the at least one constituent element as the main element and dressing element respectively to form the target virtual image of the target intelligent agent based on categories of the at least one constituent element and/or associations between the at least one constituent element; or
when the target intelligent agent does not have a virtual image, performing the generative processing on the at least one constituent element to generate a virtual image, to obtain the target virtual image of the target intelligent agent.

14. The device according to claim 10, wherein the one or more processors are further configured to perform at least one of:
using a variable parameter of the operating information to update the current virtual image of the target intelligent agent of the electronic device, such that the target intelligent agent has the target virtual image, wherein the constituent elements of the target virtual image are different from the current virtual image and/or functions and/or services that the target virtual image is able to provide are different from the current virtual image; or
obtaining usage change information of the electronic device, and configuring the target intelligent agent of the electronic device to have the target virtual image based on the usage change information and the operating information.

15. The device according to claim 10, wherein the one or more processors are further configured to perform at least one of:
performing generative processing on obtained operating application information of the electronic device to obtain a dressing element of the target intelligent agent, and synthesizing the dressing element with the current virtual image of the target intelligent agent, such that the target intelligent agent has the target virtual image including the dressing element;
performing generative processing on obtained operating mode information of the electronic device to obtain the dressing element or an element to be updated of the target intelligent agent, and updating the current virtual image of the target intelligent agent using the dressing element or the element to be updated, such that the target intelligent agent has the target virtual image that matches the current operating mode of the electronic device; or
performing generative processing on obtained operating environment information of the electronic device to obtain the dressing element or the element to be updated of the target intelligent agent, and updating the current virtual image of the target intelligent agent using the dressing element or the element to be updated, such that the target intelligent agent has the target virtual image that matches the current operating environment of the electronic device, wherein
the target intelligent agent is the only intelligent agent on the electronic device or one intelligent agent that matches the current operation application of the electronic device.

16. The device according to claim 15, wherein the one or more processors are further configured to perform at least one of:
performing the generative processing on an obtained application category or application name of the currently operating application of the electronic device to obtain the dressing element matching the application category or the application name, wherein dressing elements corresponding to different application categories are different;
performing the generative processing on obtained target window content and/or target object elements of the currently operating application of the electronic device to obtain the dressing element matching the target window content and/or the target object elements, wherein dressing elements corresponding to different target window contents are different and/or dressing elements corresponding to different target object elements are different;
when the application currently operating on the electronic device is a game application, generating the dressing element of the target intelligent agent corresponding to the game application based on game progress information and/or target props equipment information of the game application, wherein the target props equipment information is props equipment information of a target player; or
obtaining historical data of the currently operating application of the electronic device and updating a target dressing element of the target intelligent agent based on the historical data to obtain the target virtual image matching the historical data.

17. The device according to claim 10, wherein the one or more processors are further configured to perform at least one of:
determining a display area and/or a display mode of the target virtual image based on the obtained operating application information of the electronic device, to display the target virtual image in the determined display area through the determined display mode; or
updating the display area and/or display mode of the target virtual image based on variable parameters of the operating information.

18. The device according to claim 10, wherein the one or more processors are further configured to perform:
when the electronic device runs a game application, obtaining player data of the game application, wherein the player data includes player operation data and/or player account data; and
based on the player data and the target game data of the game application, updating a dressing element and/or a main element of a game intelligent agent corresponding to the game application, such that the game intelligent agent has a game virtual image that matches the player data and the target game data.

19. A non-transitory computer readable storage medium electronic device containing a computer program that, when being executed, causes at least one processor to perform:
obtaining operating information of the electronic device; and
configuring a target intelligent agent of the electronic device to have a target virtual image based on the operating information, wherein the target intelligent agent is able to update constituent elements of a virtual image of the target intelligent agent in response to a change in the operating information.

20. The storage medium according to claim 19, wherein the at least one processor is further configured to perform at least one of:
in response to the electronic device enabling the target intelligent agent, using the target intelligent agent to monitor operating application information of the electronic device;
in response to obtaining a configuration operation acting on a target interface of the electronic device, obtaining operating configuration information generated by the configuration operation;
based on at least one sensor, obtaining operating environment information of the electronic device, wherein the at least one sensor belongs to or does not belong to the electronic device; or
monitoring an operating parameter of a target component of the electronic device, and obtaining the operating information of the electronic device based on the operating parameter.
